(19) United States
(12) Patent Application Publication
(10) Pub. No.: US 2018/0133889 A1
(43) Pub. Date: May 17, 2018

(54) Rocker Handle

(71) Applicant: Steven Edward Lening, Marquand, MO (US)

(72) Inventor: Steven Edward Lening, Marquand, MO (US)

(21) Appl. No.: 15/499,270

(22) Filed: Apr. 27, 2017

Related U.S. Application Data
(60) Provisional application No. 62/337,765, filed on May 17, 2016.

(51) Int. Cl. B25G 1/10; A63B 60/14; A63B 29/08

(52) U.S. Cl. CPC B25G 1/102; B25D 1/00; A63B 29/08; A63B 60/14

(57) ABSTRACT

The Rocker Handle pertains to the field of hand-held tools and devices. A sleeve-like attachment (the receiver) becomes the new user gripping point, a replacement hand-hold. This arrangement allows the tool's encased handle to move inside the gripped receiver. The receiver attaches to and partially encases a tool's standard or custom handle. The combination of the loose fitting receiver and the encased handle movement within creates a subtle whip-like action of the tool head. The effect is a different feel and action of the modified tool. The user experiences better tool performance, expends less effort while using the tool, and has reduced risk of personal injury.

### CROSS REFERENCE

Application No.: 62/337,765

Filing Date: May 17, 2016

Inventor: Steven Edward Lening

### BACKGROUND OF THE INVENTION

This invention pertains to the field of tools and recreational devices, specifically to the handles of hand-held tools such as hammers designed for striking other objects, to handles of cutting tools such as machetes, and to handles of certain recreational devices such as mountain-climbing ice tools.

Much of the discussion in this application is focused on handles for hammers. This focus is intended to use one type of tool to illustrate as clearly as possible how the invention improves performance of tools and devices of many types. The advantages described for hammers are also achieved with other types of tools and devices to which the invention is applied.

Hammers are conceptually very simple tools. They consist of a weighted head on one end and a handle connecting the head to the hand and arm of the user. The combination of the head and handle enables the user to apply force to objects, moving, crushing or splitting the objects to accomplish a benefit for the user. For thousands of years man has made and used a wide variety of hammers. Although automated hammers such as nailing guns have become widely used, there has been almost no change through those millennia to the basic design of the hand-held hammer.

A history of hammers prepared by Heather Dueitt of NoteVault was distributed in 2016 via a blog and is available on-line. She states that the hammer may date back as long as 2.6 million years, probably starting when primitive man used stones of various shapes to crack nuts, smash bones to get to the marrow and crush other objects. By 30,000 B.C. strips of leather and animal sinews were in use to fasten stones comprising hammer heads to wooden or bone handles. Although brass began to be used for hammer heads about 3,000 B.C., the head of the oldest hammer on display at The Hammer Museum in Haines, Ak. is a rock ball made of dolerite. That hammer was found in Egypt and is associated with the building of the third pyramid at Giza, about 2500 years ago. Iron forging began about 1500 B.C. and hammer heads made of iron followed. The addition of claws for pulling nails emerged during the Roman Empire, about 150 C.E.

Throughout the long history of the hand-held hammer it has continued to consist of a handle and a head. Both are now made of a wide variety of materials. Many innovations have been developed in the metallurgy, shape and size of hammer heads and in the materials used in hammer handles. The hand-held hammer still achieves its purposes by permitting the user to apply whatever force results from the combination of the user's arm, the handle and the weighted head.

Although an almost infinite number of types of hand-held hammers have been designed, produced and used over the hammer's long history, there remain some fundamental problems in hammer design. One problem is the speed and direction needed to perform many tasks for which hammers are used. For example to drive a large nail into hard wood, the swing distance and arc the user needs to apply result in a great many bent nails and bruised fingers and thumbs. This is especially a problem for those who use hammers only occasionally.

Another problem with currently-available hammers is that of stress placed on the hands and arms of those who use hammers frequently. The impact of a hammer on the object it strikes feeds shock waves back into the hands and arms of users. Over time, this can produce nerve and muscle damage, sometimes to the point of disability, limiting or preventing use of hammers and other physical activities.

Yet another problem with hammers now available relates to the sound waves resulting from a hammer striking the intended object. This can produce hearing loss to those who use hammers frequently.

Many handle inventors have sought to reduce stress on users' hands and arms through use of new handle materials. For example, U.S. Pat. No. 5,490,437 filed Aug. 25, 1994 by Paul W. Hebert and three others conceived the insertion into tool handles of gelatinous material to absorb shock and reduce stress upon users. Similarly U.S. Pat. No. 6,370,986 filed Mar. 23, 2000 by Gary Scott provided a design concept for tool handles using layers of polypropylene or other foam materials to reduce stress upon the user.

Various patent applications have presented ideas for improving utility and/or efficiency of hand tools by attaching supplemental or auxiliary handles. For instance, U.S. Ser. No. 09/983,387 filed Oct. 22, 2001 by John Daniel Quimby provided for attachment of elongated auxiliary handles to a variety of tools.

Other applications for patents have proposed improvements in the striking force and/or accuracy of hand-held hammers. For example U.S. Pat. No. 5,280,738 filed Jul. 12, 1993 by Liou Mou-Tang postulated use of rotating hammer heads to permit access to spots not reachable by standard hammers.

No identified existing or pending patents address both the reduction of stress and resultant injury to users' arms while also increasing the force applied and improving the striking accuracy of hammers, other hand tools and other devices. The observed beneficial effects of the invention that is the subject of this application address all of these dimensions. It has the potential to revolutionize the hand-held tool industry and to have substantial impact on other fields such as recreational equipment.

### SUMMARY

The purpose of the invention is to provide added travel distance and speed to the tool head of hand-held tools. The invention, the Rocker Handle, enhances the usability of all tools with handles and tool heads, such as hammers and other hand-held tools and devices. The invention is applicable to, and can be modified to fit, all such tools and devices. Examples of hand-held tools and devices that can be improved through attachment of the Rocker Handle include hammers of many types, chefs' knives, garden rakes, axes and fishing rods. With the Rocker Handle the user applies greater force with less effort, thereby having better control of the tool and experiencing less body stress.

The Rocker Handle consists of a sleeve-like attachment (receiver), made of metal or other durable material, partially encasing a tool's handle. The tool handle may be the standard handle for the tool, or it may be a customized handle uniquely devised for adapting the tool to the Rocker Handle. When the receiver and tool handle are attached to each other, the receiver replaces the encased handle for the purpose of gripping and using the tool. The receiver's longitudinal dimension is elongated for tools that require gripping by both hands as in the case of a garden rake or sledge hammer. Some of these modifications will have both an elongated receiver and shortened tool handle. For user comfort the gripping surface can be wrapped or covered with commercially available or customized padding material.

The encased tool handle inside the receiver travels farther, along the plane of the tool's arc, than the receiver travels. This extra travel distance creates increased travel speed for the tool head, similar to a snapping or subtle whip-like motion. The increased speed creates more striking force in the tool head. The result of this extra motion gives the tool equipped with the Rocker Handle increased effectiveness.

The receiver attaches to any hand-held tool or device with a handle and tool head, one-hand grip or two-hand grip, making it adaptable to all categories of tools and devices with handles and tool heads, including the general categories of hammers, garden tools, and recreational devices.

When the invention is applied to recreational devices such as golf clubs, fishing rods and mountain-climbing ice tools, the device or tool becomes more effective in helping the user achieve the intended purposes. For example, the Rocker Handle enhances the ability of climbers to establish secure holds with less energy expenditure because the driving force of each strike of the tool is significantly increased. In the case of golf clubs, the effect of the Rocker Handle is very similar to that of a hammer application, meaning that a golf ball can be driven farther with a given club and a given swing speed than would occur if an unmodified club were used. Unmodified fishing rods already depend on whip-like dynamics to achieve casting distances. The application of the Rocker Handle will add to the whip-like effect causing the lure and line to reach distances not achievable with the unmodified rod.

The observed beneficial effects when using Rocker Handle prototypes include:

1. Imparts more speed to the attached tool head and results in better accuracy and in greater force being applied when the tool head reaches its objective;
2. Requires less effort by the user; improving tool control and effectiveness, reducing shock and stress to the user's hand and arm, and in the case of hammers reducing adverse noise effects.
3. Facilitates a staccato-like tool movement for cramped areas and for applications requiring repeated impacts;
4. Reduces user fatigue, wear and tear injuries, and potential for accidents.

### BRIEF DESCRIPTION OF DRAWING

FIG. 1 Traversing pin

FIG. 2 Receiver. A sleeve-like attachment

FIG. 3 Handle. Tool handle (standard or custom)

FIG. 4 Rocker Handle assembled

### DETAILED DESCRIPTION OF INVENTION

The Rocker Handle consists of three basic components:

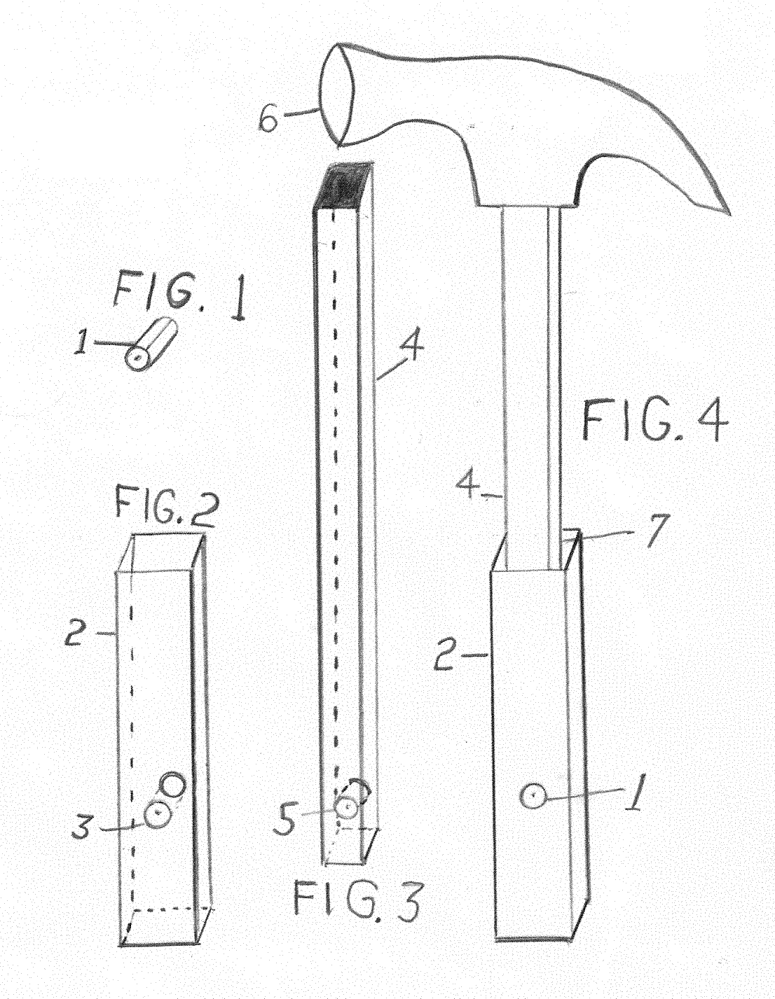

1. A specially designed sleeve-like receiver 2 shown in FIG. 2. The shape of the receiver is shown as a rectangle but in most applications will be round, oval or some other shape. The receiver 2 is made of steel or other durable materials formed into the desired shape.
2. A standard or customized tool handle 4 as shown in FIG. 3.
3. A traversing pin 1 shown in FIG. 1 as a roll pin, for connecting the receiver 2 to the handle 4. The pin 1 is made of hardened steel or other durable material. It is fastened to the receiver 2 at both ends by welding or other means.

The receiver 2 is designed for the standard or customized handle 4 of a specific tool or device. A traversing pin 1 attaches the receiver 2 to the tool handle 4. The pin 1 passes through the drilled hole 5 in the handle 4 and the drilled holes 3, one on each side of the receiver 2. Each end of the pin 1 is attached to the receiver 2.

The attachment point for the receiver and handle will vary for different tools. The attachment point is located toward the aft end of the receiver 2 for tools and devices intended for single hand use such as hammers.

For some tools requiring a two-hand grip the receiver is made longer, the attachment point is moved forward in the receiver and the tool handle length shortened. Garden rakes and sledge hammers are examples.

The attachment angle is perpendicular to the longitudinal dimensions of the handle 4 and receiver 2. It is also perpendicular to the plane of the tool head 6 arc. The positioning of the handle 4 allows clearance for the movement of both ends of the handle 4 inside the receiver 2. It also affects the travel distance of the tool head 6 relative to the travel distance of the receiver 2.

The dimensions and shape of the receiver 2 will vary for different types of tools. The shape of the receiver 2 can range from rectangular to cylindrical or oval. The length of the receiver changes the feel and effectiveness of the modified tool. For a standard claw hammer modification FIG. 4 the optimum ratio of the handle 4 length to the receiver length is 2.5 to 1, based on current prototype experience.

When an assembled tool modification FIG. 4 is in use, the travel distance of the tool head 6 is greater than the travel distance of the receiver 2. This can be visualized as a common hammer held horizontally and striking a nail. The amount of extra travel distance of the tool head 6, up and down, is both allowed and limited by the size of the opening 7 of the receiver 2. A larger opening allows greater tool head 6 travel distance. Similarly a smaller opening 7 reduces the travel distance of the tool head. The size of the opening 7 also affects the user's control of the tool head 6. Determining the optimal size of the openings includes prototype testing.

1. The inventor claims a handle modification for certain hand-held tools and other hand-held devices with handles and tool heads; consisting of an outer sleeve-like receiver attachable to a tool's or device's handle by a traversing pin, partially encasing the handle, and causing extra tool head travel speed when the tool is in use, thereby creating a more forceful whip-like action of the tool or device head.

2. The handle modification of claim 1 wherein the outer sleeve-like receiver is elongated to accommodate tool and device handles designed for two hand usage, including such tools and devices as rakes, hoes, axes, pick-axes, sledge hammers and golf clubs.

3. The handle modification of claim 1 as applied to the general category of hammers designed for one hand usage including claw hammers, ball-peen hammers, meat tenderizing hammers and hatchets.

4. The handle modification of claim 1 as applied to certain cutting tools such as machetes, weed cutters, harvesting knives, and chefs' knives.

5. The handle modification of claim 1 adapted to recreational devices designed for either one-hand or two-hand usage including mountain climbing ice tools and fishing rods.
